(19) United States
(12) Patent Application Publication
(10) Pub. No.: US 2010/0048423 A1
(43) Pub. Date: Feb. 25, 2010

(54) SIMULTANEOUS DETECTION, DIFFERENTIATION AND TYPING SYSTEM OF NEWCASTLE DISEASE AND AVIAN INFLUENZA VIRUSES

(75) Inventors: Chu-Hsiang Pan, Taipei (TW); Lih-Chiann Wang, Taipei (TW); Ching-Ho Wang, Taipei (TW); Ming-Chu Cheng, Taipei (TW); Ming-Hwa Jong, Taipei (TW); Shu-Hwae Lee, Taipei (TW); Lu-Yuan Liu, Miao-Li (TW)

Correspondence Address: RABIN & Berdo, PC, 1101 14TH STREET, NW, SUITE 500, WASHINGTON, DC, 20005, US

(73) Assignee: ANIMAL HEALTH RESEARCH INSTITUTE, COUNCIL OF AGRICULTURE, EXECUTIVE YUAN, Taipei (TW)

(21) Appl. No.: 12/194,103

(22) Filed: Aug. 19, 2008

(51) Int. Cl. C40B 40/06

(52) U.S. Cl. 506/16

(57) ABSTRACT

A simultaneous detection, differentiation and typing system of Newcastle disease and avian influenza viruses is provided. The present invention provides a system, including an oligonucleotide microarray, avian virus specific probes is disposed on the oligonucleotide microarray and the avian viruses include Newcastle disease and avian influenza viruses, and avian virus nucleic acid products, hybridized with the avian virus specific probes on the oligonucleotide microarray. The present invention describes a fast, simultaneous and inexpensive approach to the detection of Newcastle disease virus (NDV) and avian influenza virus (AIV) and possesses good sensitivity and specificity among divergent viruses. The hybridization results on microarrays were clearly identified with the naked eyes, with no further imaging equipment needed. The present invention provides potential for rapid surveillance and differential diagnosis of these two important zoonoses in both wild and domestic birds.

### BACKGROUND OF THE INVENTION

1. Field of the Invention

The invention relates to a clinical detection for avian diseases. More particularly, the invention relates to a simultaneous detection, differentiation and typing system of Newcastle disease and avian influenza viruses with both good sensitivity and specificity among divergent viruses.

2. Description of Related Art

Newcastle disease (ND) and avian influenza (AI) are two of the most devastating avian diseases in the world. Both diseases cause acute respiratory infection and lead to mortality in poultry flocks. Newcastle disease virus (NDV) and avian influenza virus (AIV) are associated with transmission from wild to domestic birds, and can lead to human infections such as conjunctivitis or influenza-like syndrome. Wild birds may function as a reservoir for both viruses, playing a role as potential vectors with few or no clinical signs. NDVs have been isolated from many free-living avian species, including Pelecaniformes, Falconiformes, Strigiformes and Anatiformes. The Anatiformes has also provided the highest rate of AIV isolations.

The pathogenicity of NDV is mainly determined by the amino acid sequence of the fusion (F0) protein cleavage site. Mutation will change the virulence from non-virulent (lentogenic) to intermediate (mesogenic) or highly virulent (velogenic) strains. There are 16 (H1-H16) haemagglutinin (HA) subtypes of AIV. The H16, a novel haemagglutinin subtype, has recently been found from blackheaded gulls. The highly pathogenic avian influenza (HPAI) viruses have been restricted to H5 and H7, although not all viruses of these subtypes cause HPAI. Others cause a milder respiratory disease, designated low pathogenicity avian influenza (LPAI) viruses. The virulence of AIV depends on the cleavage site of the haemagglutinin precursor protein (HA0). HPAI H5 and H7 can arise from the HA gene mutation of LPAI H5 and H7. The virulent determination of NDV is required, because control measures for avirulent viruses are very different from those for virulent viruses. The AIV subtyping, likewise, is imperative and most countries have recently implemented a stamping-out policy on H5 and H7 outbreaks whether it is LPAI or HPAI.

Outbreaks of ND are regular and frequent throughout Africa, Asia and parts of Central and South America. It appears to be a sporadic epizootic disease despite vaccination programs. In recent years, many outbreaks of both HPAI and LPAI have been reported in Asia and Europe. In addition, NDV and AIV H9N2 and H7N3 were isolated in various combinations in poultry flocks in Pakistan in 2001. Interestingly, a H7N3 virus showing close genetic similarity to the Pakistan virus was isolated from a peregrine falcon (Falco peregrinus) in the United Arab Emirates prior to the outbreak. All of these indicate the necessity for detecting and typing NDV and AIV in both wild and domestic birds in order to quickly prevent and control the epidemics. Both NDV and AIV may cause serosal haemorrhages of the gastrointestinal tract and be difficult to discriminate. Therefore, differential diagnosis is imperative.

Many rapid serosurveys of both NDV and AIV have been done in wild and domestic birds in recent years. However, the antibodies against NDV and AIV were examined as two separate procedures, with no pathogenicity and subtype information obtained in these investigations except for performing further molecular manipulations. Some molecular approaches have been applied to NDV detection and pathotyping, e.g. reverse transcription polymerase chain reaction (RT-PCR) followed by restriction endonuclease analysis, real-time PCR and real-time reverse-transcription PCR (RRT-PCR). A number of molecular methods for the detection of AIV and subtyping of H5 and H7 have also been developed, e.g. RT followed by enzyme-linked immunosorbent assay, multiplex RRT-PCR combined with haemagglutinin inhibition test, and RRT-PCR targeting matrix and haemagglutinin genes with separate procedures.

Nucleic acid sequence-based amplification (NASBA) was employed to detect AIV H5 or H7. Using microarrays to type and subtype human influenza viruses has been recently reported; however, none focused on the detection of avian viruses. No integrated manipulations have been reported so far to detect NDV and AIV simultaneously, although these two viruses are important wild bird-carried zoonoses and the intervention of differential diagnosis is needed in many cases.

In addition, multiplex RT-PCR increased the detection efficiency of multiple viruses. However, it was unable to differentiate the NDV pathotypes, as well as the specific AIV subtypes. These meant that further differentiation was required. Furthermore, confused signs between ND and AI happen frequently, as both may cause gastrointestinal tract haemorrhage in birds and conjunctivitis in humans. All of these issues reveal that detection, differentiation and typing of these two groups of viruses are critical. However, no integrated methods have been developed that are able to achieve this purpose simultaneously. Neither a serological method nor the RT-PCR method has so far been developed to carry this out.

### SUMMARY OF THE INVENTION

Accordingly, the present invention is directed to a simultaneous detection, differentiation and typing system of Newcastle disease and avian influenza viruses. It is a rapid approach to differentiate NDV and AIV by using oligonucleotide microarrays. The NDV pathotypes and the AIV haemagglutinin subtypes H5 and H7 were determined simultaneously. This system, thus, may provide a new avenue to rapid detection, differentiation and typing of multiple pathogens. It could also be used to screen for potential carriers in both wild and domestic birds.

The present invention provides a simultaneous detection, differentiation and typing system of Newcastle disease and avian influenza viruses, which comprises an oligonucleotide microarray, avian virus specific probes is disposed on the oligonucleotide microarray and the avian viruses include Newcastle disease and avian influenza viruses, and avian virus nucleic acid products are hybridized with the avian virus specific probes on the oligonucleotide microarray.

According to an embodiment of the present invention, the avian virus specific probes are selected from at least one of Newcastle disease virus (NDV) probe sequences of SEQ ID No. 1˜5.

According to an embodiment of the present invention, the avian virus specific probes are selected from at least one of avian influenza virus (AIV) probe sequences of SEQ ID No. 6˜22.

According to an embodiment of the present invention, the avian virus nucleic acid products are amplified from multiplex RT-PCR utilizing at least one of avian virus specific primers.

According to an embodiment of the present invention, the avian virus specific primers are selected from at least one of AIV primer sequences of SEQ ID No. 23˜36.

According to an embodiment of the present invention, the oligonucleotide microarray is set on a biochip or a DNA chip.

According to an embodiment of the present invention, each of the specific probes is disposed to each specific position of the microarray and the hybridization on the microarray produces identified patterns.

Since the novel probes and primers are developed and multiplex RT-PCR and hybridization reaction are combined through oligonucleotide microarrays in the system, the present invention develops an integrated approach for manipulating NDV and AIV rapidly and simultaneously. Viral detection, differentiation and typing were successfully achieved utilizing oligonucleotide microarrays. NDV, the velogenic and mesogenic pathotypes of NDV, the lentogenic pathotype of NDV, AIV, the H5 subtype of AIV, the H7 subtype of AIV, the H1 subtype of AIV, the H3 subtype of AIV, the H6 subtype of AIV and the H9 subtype of AIV were all clearly identified at the same time.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

Table 1 shows the virus strains of NDV used in the embodiments of the present invention.

Table 2A and 2B show the virus strains of AIV used in the embodiments of the present invention.

Table 3 show the probe oligonucleotides designed in the present invention.

Table 4A shows the probe oligonucleotides of SEQ ID No. 1˜5 designed in the present invention.

Table 4B shows the probe oligonucleotides of SEQ ID No. 6˜22 designed in the present invention.

Table 5 shows the primer oligonucleotides of SEQ ID No. 23˜36 designed in the present invention.

FIG. 1 shows the gel electrophoresis of multiplex RT-PCR with four pairs of primers, NDV-F, AIV-M, AIV-H5 and AIV-H7 in embodiments of the present invention.

FIG. 2 shows the detection and typing of each NDV or AIV isolated by using oligonucleotide microarrays in embodiments of the present invention.

FIG. 3 shows the simultaneous detection, differentiation and typing of NDV and AIV using oligonucleotide microarrays in embodiments of the present invention.

FIG. 4 shows the gel electrophoresis of multiplex RT-PCR with four pairs of primers, AIV-H1, AIV-H3, AIV-H6 and AIV-H9 in embodiments of the present invention.

FIG. 5 shows the detection and typing of each NDV isolated by using oligonucleotide microarrays in embodiments of the present invention.

FIG. 6 shows the detection and typing of four AIV subtypes by using oligonucleotide microarrays in embodiments of the present invention.

### DETAILED DESCRIPTION OF THE PREFERRED EMBODIMENTS

Reference will now be made in detail to the present embodiments of the invention, examples of which are illustrated in the accompanying drawings. Wherever possible, the same reference numbers are used in the drawings and the description to refer to the same or like parts.

Taught herein is a simultaneous detection, differentiation and typing system of Newcastle disease and avian influenza viruses, which comprises an oligonucleotide microarray, avian virus specific probes is disposed on the oligonucleotide microarray and the avian viruses include Newcastle disease and avian influenza viruses, and avian virus nucleic acid products are hybridized with the avian virus specific probes on the oligonucleotide microarray.

In one embodiment of the present invention, the avian virus specific probes are selected from at least one of Newcastle disease virus (NDV) probe sequences of SEQ ID No. 1˜5.

In one embodiment of the present invention, the avian virus specific probes are selected from at least one of avian influenza virus (AIV) probe sequences of SEQ ID No. 6˜22.

In one embodiment of the present invention, the avian virus nucleic acid products are amplified from multiplex RT-PCR utilizing at least one of avian virus specific primers.

In one embodiment of the present invention, the avian virus specific primers are selected from at least one of AIV primer sequences of SEQ ID No. 23˜36.

In one embodiment of the present invention, the oligonucleotide microarray is set on a biochip or a DNA chip.

In one embodiment of the present invention, each of the specific probes is disposed to each specific position of the microarray and the hybridization on the microarray produces identified patterns.

The present invention provides a simultaneous detection, differentiation and typing system of Newcastle disease and avian influenza viruses, which could use multiple probes of different oligonucleotide sequences with different combination of viruses. For clear and further statement, the detail is illustrated by the following embodiments of the present invention.

Table 1 shows the virus strains of NDV used in the embodiments of the present invention. Table 2A and 2B show the virus strains of AIV used in the embodiments of the present invention. In Table 1, 2A and 2B, the annotation a interprets that A represents virulent strains originated from National Taiwan University, B represents vaccine strains, C represents stains provided by Dr. H. Kida, D represents strains provided by Dr. R. G. Webster and E represents strains from Council of Agriculture, Taiwan. The other strains are from Field isolate, wherein the A/Q156 (H5N1) is from Chinmen isolates. In Table 1, the annotation b interprets that the Roman numeral shown in parentheses is the genotype of NDV.

The virus strains used in the embodiments, including the mean egg embryo infective dose (EID₅₀) of each virus, are shown in Table 1. Two NDV virulent strains, TW-2/00 from chickens and Ow/Tw/2209/95 from an owl, were field isolates originated from the Graduate Institute of Veterinary Medicine, National Taiwan University. Five commercial NDV vaccine strains, the lentogentic pathotype, were used here. The B1 and VG/GA strains were obtained from MERIAL (Gainesville, Ga., USA), La Sota and PHY-LMV-42 strains were from CEVAC (Budapest, Hungary), and Clone 30 strain was from INTERVET (Boxmeer, Holland). The two H5 and two H7 subtypes of AIV were obtained from the Epidemiology Division of the Animal Health Research Institute, Council of Agriculture, Tamsui, Taiwan. Other AIV strains were obtained from Dr. H. Kida at the School of Veterinary Medicine, Hokkaido University, Sapporo, Japan, or from Dr. R. G. Webster at St. Jude Children's Research Hospital, Memphis, Tenn.

Table 3 shows the probe oligonucleotides designed in the present invention. Table 4A shows the probe oligonucleotides of SEQ ID No. 1˜5 designed in the present invention. Table 4B shows the probe oligonucleotides of SEQ ID No. 6˜22 designed in the present invention. In Table 3, 4A and 4B, NDV represents Newcastle Disease Virus, AIV represents Avian Influenza Virus, H represents Hemagglutinin (HA) gene, M represents Matrix (M) gene, EA represents AIV Europe/Asia type, America represents AIV America type, u represents Universal, NDV-vm represents NDV Virulent, Mesogenic type probe and NDV-11 and NDV-12 represent Vaccine type probe.

Table 5 shows the primer oligonucleotides of SEQ ID No. 23˜36 designed in the present invention. In another denomination, AIM-f/r is cM-1F/1R, AIH5-f/r is cH5-1F/1R and AIH7-f/r is cH7-2F/2R. The length of RT-PCR products is shown as following. The products consisted of 389 bp for cH5-1F/1R, 512 bp for cH7-2F/2R, 155 bp for cM-1F/1R, 149 bp for cH1-1F/1R, 379 bp for cH3-4F/4R, 449 bp for cH6-3F/3R and 184 bp for cH9-2F/1R.

Sequences of the primer pair, ALLs and ALLe, specific for fusion (F) protein gene of NDV have been previously described. Primers based on conserved sequences of the matrix (M) protein gene of AIV, and the haemagglutinin gene of AIV subtypes H5 and H7 were designed in the present invention. The universal probes targeting all NDV and all AIV were designed from the conserved sequences of NDVF protein gene and AIV-M protein gene, respectively. The NDV pathotype probes were designed to anneal to the F cleavage site of NDV. The AIV H5 and H7 subtype probes were designed from the corresponding genes of HA0 cleavage proteins, HA1 and HA2, respectively. All of the designs for primers and probes were derived from the alignments and analyses of the nucleotide sequences retrieved from the enormous GenBank data, and conducted by the MegAlign program (DNASTAR, Madison, Wis., US). The sequences of designed primers and probes are listed in Table 3A, 3B and 4.

Viruses were grown in the allantoic cavities of 9- to 10-day-old embryonated fowl eggs originating from a commercial specific pathogen free flock. Viral RNA was extracted from infective allantoic fluid using QIAamp viral RNA kit (Qiagen, Valencia, Calif.). Multiplex RT-PCR was performed using SuperScript one-step RT-PCR kit (Invitrogen, Carlsbad, Calif.). Eight pairs of 5′ end-biotinylated primers, ALLs/ALLe of NDV, AIM-f/r of AIV, AIH5-f/r of AIV, AIH7-f/r of AIV, AIH1-f/r of AIV, AIH3-f/r of AIV, AIH6-f/r of AIV, and AIH9-f/r of AIV, were divided into two groups (Group 1: ALLs/ALLe, AIM-f/r, AIH5-f/r and AIH7-f/r. Group 2: cH1-1F/1R, cH3-4F/4R, cH6-3F/3R and cH9-2F/1R) and employed in two separate multiplex RT-PCR reactions. The multiplex RT-PCR was carried out in a reaction volume of 50 μl containing 1 μl of each primer (10 μM), 1 μl of RT/Platinum Taq Mix, 25 μl of 2× Reaction Mix and 5 μl of each template RNA. The thermal profile for amplification was 42° C. for 40 min, 94° C. for 3 min, 35× (94° C. for 50 s, 50° C. for 50 s, and 72° C. for 50 s), 72° C. for 7 min. The multiplex RT-PCR products were separated in 4% agarose gels (Gibco, Grand Island, N.Y.), run in 0.5×TAE buffer with 0.5 μg/ml ethidium bromide (Gibco, Grand Island, N.Y.) at 100 V for 50 min, and visualized under UV light.

A tail composed of 19 T bases was added on each 5′ end of oligonucleotide probe, including the positive control probe (an oligonucleotide from capsid protein VP1 of human enterovirus 71 gene, 5′-ATGAAGCATGTCAGGGCTTGGATACCTCG-3′). Ten μM of each probe was then spotted to each specific position on the microarray polymer substrate using an automatic spotting machine (DR. Easy spotter, Miao-Li, Taiwan), and immobilized by a UV Crosslinker (Vilber Lourmat BLX-254, ECC, Marne, France) with 1.2 J for 5 min.

The hybridization reaction between each DNA template and probe was carried out with DR. Chip DIY™ Kit (DR. Chip Biotech, Miao-Li, Taiwan). The procedures followed the manual and are briefly described below. The PCR product was denatured at 95° C. for 10 min, and cooled in an ice bath for 2 min. To the microarray chamber was added 200 μl of Hybridization Buffer (containing the 5′ end-biotinylated oligonucleotide complementary to the sequence of positive control probe) and 15 μl of denatured PCR product from the multiplex RT-PCR, incubated at 50° C. with vibration for 50 min, and washed twice with Wash Buffer. The blocking reaction was then performed by mixing 0.2 μl of Strep-AP (Streptavidin conjugate alkaline phosphates) and 200 μl of Blocking Reagent at room temperature for 30 min, and washing twice with Wash Buffer. The calorimetric reaction was then implemented by adding 4 μl of NBT/BCIP and 196 μl of Detection Buffer in the chamber, developing in the dark at room temperature for 5 min, and washing twice with distilled water. The hybridization result was indicated as the developed pattern on the microarray, which was read directly with the naked eyes.

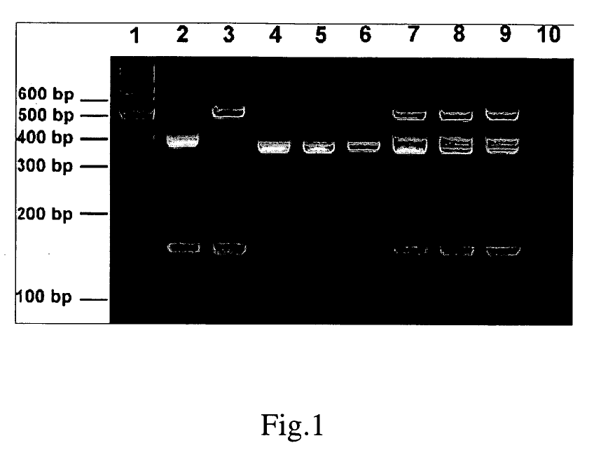

FIG. 1 shows the gel electrophoresis of multiplex RT-PCR with four pairs of primers, NDV-F, AIV-M, AIV-H5 and AIV-H7 in embodiments of the present invention. In FIG. 1, Lane 1 represents DNA marker, Lane 2 represents AIV H5N2 (Influenza A/Chicken/Taiwan/1209/03), Lane 3 represents AIV H7N7 (DK/TPM/A45/03), Lane 4 represents NDV virulent strain from chicken (TW-2/00), Lane 5 represents NDV virulent strain from owl (Ow/Tw/2209/95), Lane 6 represents NDV vaccine strain (VG/GA), Lanes 7˜9 represent AIV H5N2 (Influenza A/Chicken/Taiwan/1209/03) and AIV H7N7 (DK/TPM/A45/03) combined with different NDV strain: TW-2/00 (Lane 7), Ow/Tw/2209/95 (Lane 8), or VG/GA (Lane 9) and Lane 10 represents negative control.

A multiplex RT-PCR with four pairs of primers, NDV-F, AIV-M, AIV-H5 and AIV-H7, is developed prior to the microarray tests. The PCR product gel electrophoresis is shown in FIG. 1. The products consisted of 363 bp for NDV, 156 bp for AIV-M, 389 bp for AIV-H5 and 512 bp for AIV-H7. The NDVF and AIV-M bands in theory appeared in all tested NDV and AIV, respectively.

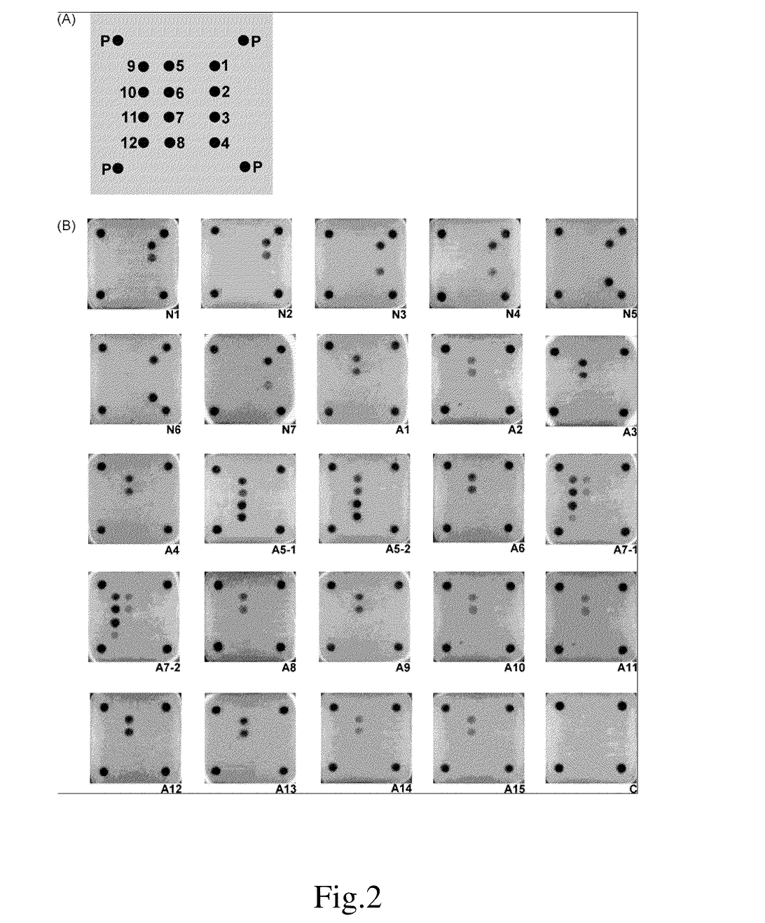

FIG. 2 shows the detection and typing of each NDV or AIV isolated by using oligonucleotide microarrays in embodiments of the present invention. In FIG. 2, part (A) shows the microarray map. Each dot indicates the spotted position of each probe. 1: NDV-u; 2: NDV-vm; 3: NDV-11; 4: NDV-12; 5: AI-u1; 6: AI-u2; 7: AIH5-1; 8: AIH5-2; 9: AIH7-1; 10: AIH7-2; 11: AIH7-3; 12: AIH7-4. P: positive control. In FIG. 2, part (B) shows the detection and typing results shown on the microarrays. N1˜N7 show each different NDV strain. N1:TW-2/00; N2: Ow/Tw/2209/95; N3: B1; N4: La Sota; N5: VG/GA; N6: PHY-LMV-42; N7: Clone 30. A1-A15 indicate different AIV haemagglutinin subtype, from H1 to H15, respectively. The strain employed for each subtype is shown in Table 1. The strain exhibited in A5-1 and A5-2 is Influenza A/Chicken/Taiwan/1209/03 (H5N2) and Influenza A/Black duck/New York/184/1988 (H5N2), respectively. The strain shown in A7-1 and A7-2 is Influenza A/Mallare/Ohio/322/1998 (H7N3) and DK/TPM/A45/03 (H7N7), respectively. C: Negative control.

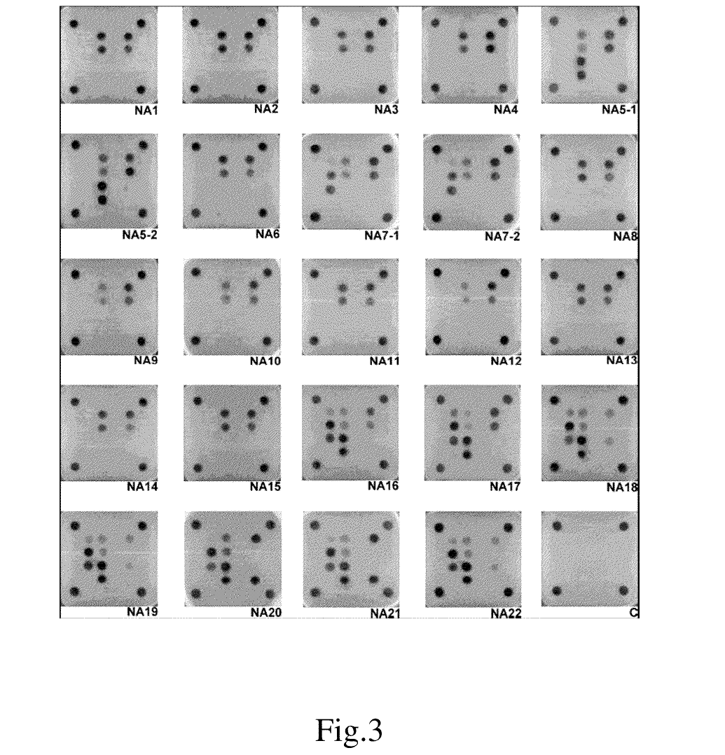

FIG. 3 shows the simultaneous detection, differentiation and typing of NDV and AIV using oligonucleotide microarrays in embodiments of the present invention. The microarray probe map is the same as part (A) of FIG. 2. NA1˜NA15 show the combination of NDV TW-2/00 strain with different AIV haemagglutinin subtype, from H1 to H15, respectively. The AIV strain used for each subtype is shown in Table 1. The AIV strain employed in NA5-1 and NA5-2 is Influenza A/Chicken/Taiwan/1209/03 (H5N2) and Influenza A/Black duck/New York/184/1988 (H5N2), respectively. The AIV strain employed in NA7-1 and NA7-2 is Influenza A/Mallare/Ohio/322/1998 (H7N3) and DK/TPM/A45/03 (H7N7), respectively. NA16-NA22 indicates the combination of AIV H5N2 (Influenza A/Chicken/Taiwan/1209/03) and H7N7 with each followed NDV strain: TW-2/00 (NA16), Ow/Tw/2209/95 (NA17), B1 (NA18), La Sota (NA19), VG/GA (NA20), PHY-LMV-42 (NA21), Clone 30 (NA22). C: Negative control.

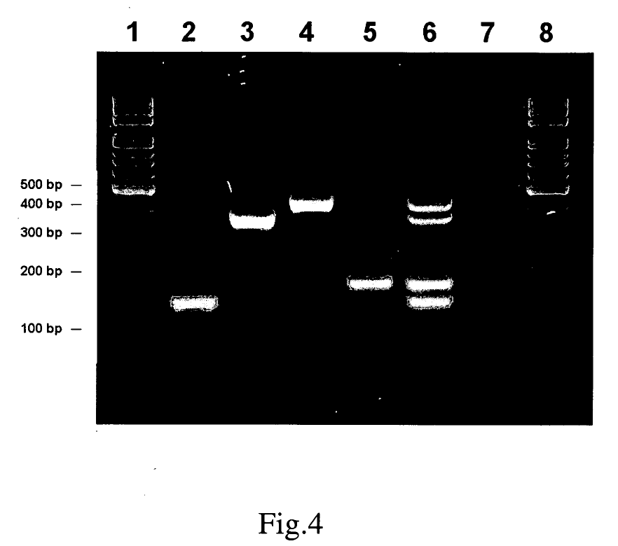

FIG. 4 shows the gel electrophoresis of multiplex RT-PCR with four pairs of primers, AIV-H1, AIV-H3, AIV-H6 and AIV-H9 in embodiments of the present invention. In FIG. 4, Lane 1 and Lane 8 represents DNA marker; Lane 2 represents AIV H1N1; Lane 3 represents AIV H3N8; Lane 4 represents AIV H6N5; Lane 5 represents AIV H9N2; Lane 6 represent multiplex RT-PCR amplification of AIV H1N1, H3N8, H6N5 and H9N2; Lane 7 represents negative control. A multiplex RT-PCR with four pairs of primers, AIV-H1, AIV-H3, AIV-H6 and AIV-H9, is developed prior to the microarray tests. The PCR products on gel electrophoresis are shown in FIG. 4. The products consisted of 149 bp for AIV-H1, 379 bp for AIV-H3, 449 bp for AIV-H6 and 184 bp for AIV-H9.

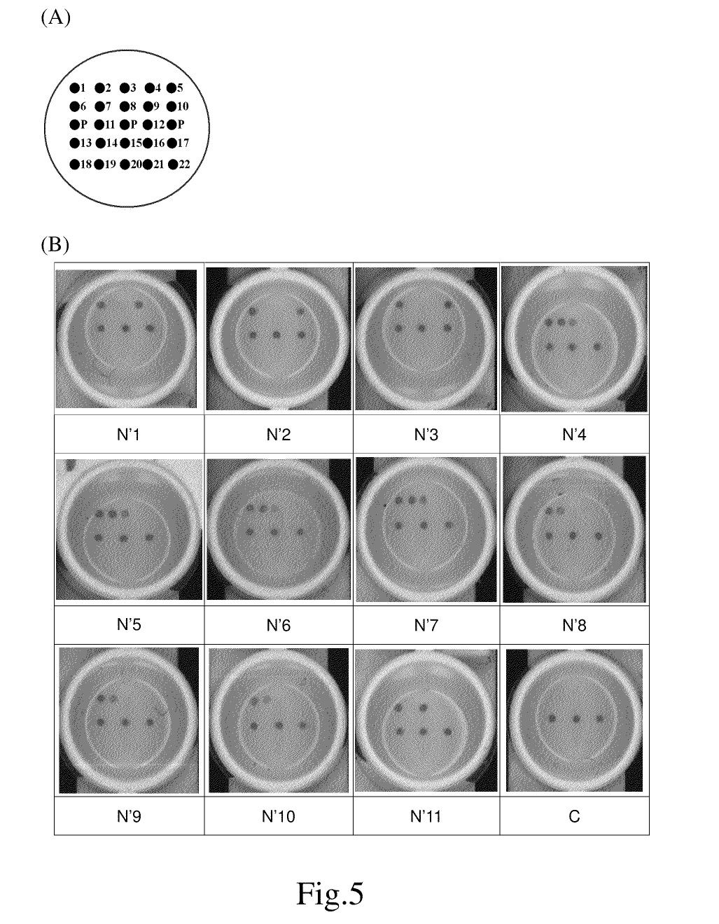

FIG. 5 shows the detection and typing of each NDV isolated by using oligonucleotide microarrays in embodiments of the present invention. In FIG. 5, part (A) shows the microarray map. Each dot indicates the spotted position of each probe. 1: NDV-u; 2: NDV-vm; 3: NDV-vm-2; 4: NDV-11; 5: NDV-12; 6: AIV-M-u1; 7: AIV-H5-u1; 8: AIV-H5-u2; 9: AIV-H5-u3; 10: AIV-H5N1; 11: AIV-H7-E.A.-1; 12: AIV-H7-E.A.-2; 13: AIV-H7-America; 14: AIV-H7-equine; 15: AIV-H9-E.A.; 16: AIV-H9-America; 17: AIV-H6-E. A.; 18: AIV-H6-America; 19: AIV-H1-u1; 20: AIV-H1-u2; 21: AIV-H3-u1; 22: AIV-H3-u2; P: Hybridization control. In FIG. 5, part (B) shows the detection and typing results shown on the microarrays. N′1˜N′11 show different NDV strain. N′1: NDV-La Sota; N′2: NDV-VG/GA; N′3: NDV-PHY-LMV-42; N′4: NDV-TW-2/00; N′5: NDV-Ow/Tw/2209/95; N′6: NDV-950111; N′7: NDV-690202; N′8: NDV-060901; N′9: NDV-691036; N′10: NDV-010401; N′11: NDV-95-3-17; C: Negative control.

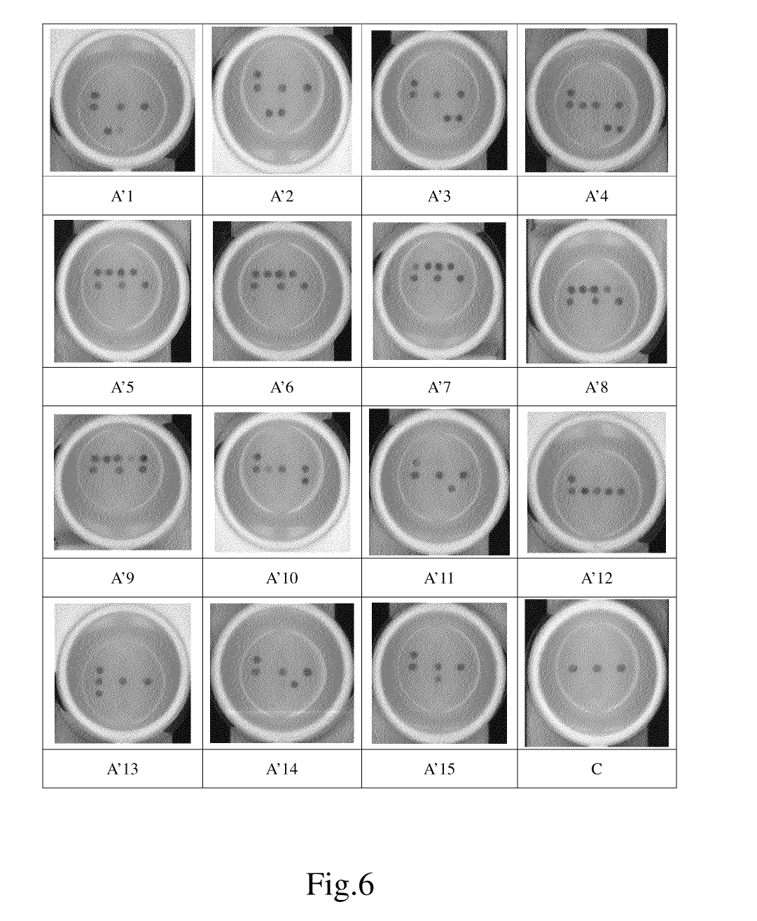

FIG. 6 shows the detection and typing of four AIV subtypes by using oligonucleotide microarrays in embodiments of the present invention. The microarray map is the same as part (A) of FIG. 5. In FIG. 6, A′1˜A′15 indicate different AIV haemagglutinin subtype. A′1: H1N1/A/PR/8/34; A′2: H1N1/Taiwan/Swine/08; A′3: H3N2/Taiwan/Swine/k88004; A′4: H3N8/Duck/Ukrine/1/63; A′5: H5N2/1209/03; A′6: H5N2/New York/184/1988; A′7: H5N3/dk/hk/820/80; A′8: H5N6/WB552; A′9: H5N1/Q156; A′10: H6N11WB329; A′11: H6N5/Australia/1/72; A′12: H7N7 DK/TPM/A45/03; A′13: H7N3/WB787; A′14: H9N2/A/Turkey/Wisconsin/1/66; A′15: H9N2/S1; C: Negative control.

Twenty-four each virus isolates (as shown in FIG. 2), twenty-six each virus isolates (as shown in FIG. 5 and FIG. 6) and twenty-four various combinations of NDV and AIV viruses (as shown in FIG. 3) were tested using oligonucleotide microarrays following the multiplex RT-PCR. Multiple probes of different oligonucleotide sequences targeting the same gene were employed on microarrays, making the divergent strains of viruses detectable or making the identified results multiply confirmed. All viruses were unambiguously detected and typed, and no cross-reactions among non-related probes were found. The hybridization signals on microarrays indicated by colorimetry in the embodiments made the results clearly identifiable using the naked eyes, that is, no additional imaging equipment was needed here. This finding shows that the simultaneous detection, differentiation and typing of NDV and AIV can be inexpensively and easily available using oligonucleotide microarrays. This approach may provide a new method for rapid recognition and differential diagnosis of these two important zoonoses, and allow screening for the potential carriers in both wild and domestic birds.

The present invention provides a simultaneous detection, differentiation and typing system of Newcastle disease and avian influenza viruses. It develops an integrated approach for manipulating NDV and AIV rapidly and simultaneously. Viral detection, differentiation and typing were successfully achieved utilizing oligonucleotide microarrays. NDV, the velogenic and mesogenic pathotypes of NDV, the lentogenic pathotype of NDV, AIV, the H5 subtype of AIV, the H7 subtype of AIV, the H1 subtype of AIV, the H3 subtype of AIV, the H6 subtype of AIV and the H9 subtype of AIV were all clearly identified at the same time.

Lots of genetic information is gained at one time based on the ability of DNA to spontaneously find and bind to its complementary probes on microarrays by hybridization. Different targeting probes performing cooperatively or complementarily make the obtained results clear and definite. These properties make the oligonucleotide microarray a good means for multiple-genetic manipulation. The detection limit of the agarose gel using Influenza A/Chicken/Taiwan/1209/03 (H5N2) as a sample was 3.6×10² to 3.6×10¹ EID₅₀/ml. The detection limit of the oligonucleotide microarray, instead, was proved to be 3.6 EID₅₀/ml (data not shown). It indicated that the sensitivity of the oligonucleotide microarray was ten to 100 times higher than the agarose gel. Therefore, a method providing a more adequate and detailed diagnosis of both NDV and AIV is achieved here.

The intensity of each hybridized dot on an oligonucleotide microarray is determined by several factors combined, such as the quality of the biotin conjugated to the primer, the concentration of the RNA template and the RT-PCR product, the length of the probe and the corresponding DNA target, and how perfectly the probe and the target match each other. The dot intensity gets great when there is good quality of the conjugated biotin, the concentration of the RNA template and the RT-PCR product is high, the length of the conserved nucleotide sequences among the viruses is enough to design a longer probe, the length of the corresponding DNA target is shorter, and there is perfect sequence complementation between the probe and its target.

The present invention has developed a rapid system for detecting both NDV and AIV, by which the NDV pathotypes and the AIV haemagglutinin subtypes H5 and H7 were simultaneously identified. The oligonucleotide microarray, thus, may provide a new avenue to recognition and differentiation of these two important zoonoses, and may be employed to screen for potential carriers in wild and domestic birds.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

TABLE 1

| Virus strain | Source and accession number^{a} | EID₅₀/ml |
|---|---|---|
| Newcastle disease virus | | |
| TW-2/00 (VIIa)b | A | 1.2 × 10⁹ |
| Ow/Tw/2209/95 (VIIa) | A (AF164966) | 2.0 × 10⁹ |
| B1 (II) | B | 3.2 × 10⁷ |
| La Sota (II) | B | 3.2 × 10⁷ |
| VG/GA (I) | B | 1.0 × 10⁸ |
| PHY-LMV-42 (II) | B | 2.0 × 10⁸ |
| Clone 30 (II) | B | 1.0 × 10⁸ |
| NDV-950111 | Field isolate | |
| NDV-690202 | Field isolate | |
| NDV-060901 | Field isolate | |
| NDV-691036 | Field isolate | |
| NDV-010401 | Field isolate | |
| NDV-95-3-17 | Field isolate | |

TABLE 2A

| | Source and | |
|---|---|---|
| Virus strain | accession number^{a} | EID₅₀/ml |
| Avian influenza virus | | |
| Influenza A/PR/8/34 (H1N1) | C | 2.0 × 10⁹ |
| Influenza A/Singapore/1/57 (H2N2) | C | 1.2 × 10⁷ |
| Influenza A/Duck/Ukrine/1/63 (H3N8) | C | 3.2 × 10⁶ |
| Influenza A/Duck/Czechoslovakia/56 | C | 2.1 × 10⁷ |
| (H4N6) | | |
| Influenza A/Chicken/Taiwan/1209/03 | E (AY573917) | 3.6 × 10⁷ |
| (H5N2) | | |
| Influenza A/Black duck/New | E (CY014872) | 4.6 × 10⁶ |
| York/184/1988 (H5N2) | | |
| Influenza A/Shearwater/Australia/1/72 | C | 2.5 × 10⁶ |
| (H6N5) | | |
| Influenza A/Mallare/Ohio/322/1998 | E (CY016188) | 2.8 × 10⁷ |
| (H7N3) | | |
| DK/TPM/A45/03 (H7N7) | E | 4.8 × 10⁸ |

TABLE 2B

| | | |
|---|---|---|
| Influenza A/Turkey/Ontario/6118/68 | C | 1.5 × 10⁷ |
| (H8N4) | | |
| Influenza A/Turkey/Wisconsin/1/66 | C | 4.2 × 10⁶ |
| (H9N2) | | |
| Influenza A/Chick/Germany/N/49 | C | 8.2 × 10⁶ |
| (H10N7) | | |
| Influenza A/Duck/England/56 (H11N6) | C | 1.3 × 10⁶ |
| Influenza A/Duck//Alberta/60/76 | C | 7.4 × 10⁶ |
| (H12N5) | | |
| Influenza A/Gull/Maryland/704/77 | C | 4.8 × 10⁶ |
| (H13N6) | | |
| Influenza A/Gull/Mallard/Gurjev/263/82 | D | 6.2 × 10⁶ |
| (H14N5) | | |
| Influenza A/Duck/Australia/341/83 | D | 4.8 × 10⁶ |
| (H15N8) | | |
| A/Taiwan/Swine/08 (H1N1) | Field isolate | |
| A/Taiwan/Swine/k88004 (H3N2) | Field isolate | |
| A/dk/hk/820/80 (H5N3) | Field isolate | |
| A/WB 552 (H5N6) | Field isolate | |
| A/Q156 (H5N1) | Chinmen isolates | |
| A/WB329 (H6N1) | Field isolate | |
| A/WB787 (H7N3) | Field isolate | |
| A/S1 (H9N2) | Field isolate | |

TABLE 3

| | | Targeted gene |
|---|---|---|
| Probe | Sequence | or virus type |
| NDV-u | 5′-GCCCAAGGATAARGAGGCGTGTGC-3′ | All patho- |
| | | types of NDV |
| NDV-vm | 5′-AGRCARAAACGMTTTATAG-3′ | Velogenic and |
| | | mesogenic |
| | | pathotypes of |
| | | NDV |
| NDV-11 | 5′-AGACAGGGGCGCCTTATAG-3′ | Lentogenic |
| | | (vaccine) |
| | | pathotype of |
| | | NDV |
| NDV-12 | 5′-GGGAAACAGGGACGYCTTAT-3′ | Lentogenic |
| | | (vaccine) |
| | | pathotype of |
| | | NDV |
| AI-u1 | 5′-CCGARATCGCGCAGAGACTTGAAGAT | All subtypes |
| | G-3′ | of AIV |
| AI-u2 | 5′-CCTCAAAGCCGARATCGCGCAGAGAC | All subtypes |
| | T-3′ | of AIV |
| AIH5-1 | 5′-GGAAACCCAATGTGTGACGAATTCATC | H5 subtype of |
| | AATGTGCCGGAATGGTCTTAC-3′ | AIV |
| AIH5-2 | 5′-GGAAACCCAATGTGTGATGAATTCCTG | H5 subtype of |
| | AATGTACCGGAATGGTCATAC-3′ | AIV |
| AIH7-1 | 5′-CAAATTGACCCAGTCAAATTGAGTA- | H7 subtype of |
| | 3′ | AIV |
| AIH7-2 | 5′-CAGATTGATCCAGTCAARTTGAGCA- | H7 subtype of |
| | 3′ | AIV |
| AIH7-3 | 5′-CAGATTGACCCAGTCAAACTRAGCA- | H7 subtype of |
| | 3′ | AIV |
| AIH7-4 | 5′-CAGATAGACCCAGTGAAATTGAGTA- | H7 subtype of |
| | 3′ | AIV |

TABLE 4A

| SEQ | | |
|---|---|---|
| ID | | |
| NO. | Oligonucleotide | Probe Sequence |
| 1 | NDV-u | 5′-GCCCAAGGATAARGAGGCGTGTGC-3′ |
| 2 | NDV-vm | 5′-AGRCARAAACGMTTTATAG-3′ |
| 3 | NDV-vm-2 | 5′-GAGAAGACGGAARCGCTTTATA-3′ |
| 4 | NDV-11 | 5′-AGACAGGGGCGCCTTATAG-3′ |
| 5 | NDV-12 | 5′-GGGAAACAGGGACGYCTTAT-3′ |

TABLE 4B

| | | |
|---|---|---|
| 6 | AIV-M-u1 | 5′-CCTCAAAGCCGARATCGCGCAGAGACT-3′ |
| 7 | AIV-H5-u1 | 5′-CCWATGTGTGACGAATTCATCAATGTGCCGGAATG-3′ |
| 8 | AIV-H5-u2 | 5′-CCAATGTGTGATGAATTCCTGAATGTACCGGAATG-3′ |
| 9 | AIV-H5-u3 | 5′-GTGTGATGAGTTCCTAAACGCAYCGGAGTG-3′ |
| 10 | AIV-H5N1 | 5′-GCTCTGCGATCTAGAYGGAGTG-3′ |
| 11 | AIV-H7-EA-1 | 5′-GTACAGGGAAGAGGCAATGCAAAATAGA-3′ |
| 12 | AIV-H7-EA-2 | 5′-ATACAGAGAAGAAGCAATGCAAAATAGA-3′ |
| 13 | AIV-H7-America | 5′-ACCATACYCAATACAGAACAGAGTCATT-3′ |
| 14 | AIV-H7-equine | 5′-GACTAGAGATTCTATCATCGAAGTAT-3′ |
| 15 | AIV-H9-E.A. | 5′-ACCCTRTTCAAGACGCCCAATACAC-3′ |
| 16 | AIV-H9-America | 5′-ACCCTTTTCAGAACGCTCATTACAC-3′ |
| 17 | AIV-H6-E.A. | 5′-CCTTGGTGTGTATCAAATTCTYGC-3′ |
| 18 | AIV-H6-America | 5′-GCATCAACTCAGTTAARAATGGCAC-3 |
| 19 | AIV-H1-u1 | 5′-GCAGACACAHTATGTATAGGCTACCATGC-3′ |
| 20 | AIV-H1-u2 | 5′-GCTGACACCATCTGTGTAGGCTACC-3′ |
| 21 | AIV-H3-u1 | 5′-GGGACTGCACACTRATAGATGCCCTACTGG-3′ |
| 22 | AIV-H3-u2 | 5′-CTGCACACTGATAGATGCTCTATTGGG-3′ |

TABLE 5

| SEQ | | |
|---|---|---|
| ID | | |
| NO. | Oligonucleotide | Primer Sequence |
| 23 | cH5-1F | 5′-GACCAGATYTGCATYGGTTAYCATGCA-3 |
| | (AIH5-f) | |
| 24 | cH5-1R | 5′-CCTGATGAGGCTTCATGRYTGGACCAAGA-3′ |
| | (AIH5-r) | |
| 25 | cH7-2F | 5′-CATCAAAATGCACAAGGRGA-3′ |
| | (AIH7-f) | |
| 26 | cH7-2R | 5′-AAACATGATGCCCCGAAGCTAAACCA-3′ |
| | (AIH7-r) | |
| 27 | cM-1F | 5′-TGAGYCTTCTAACCGAGGTCGAAACG-3′ |
| | (AIM-f) | |
| 28 | cM-1R | 5′-CAGGATTGGTCTTGTCTTTAGCC-3′ |
| | (AIM-r) | |
| 29 | cH1-1F | 5′-AGCAAAAGCAGGGGAAAATAAAADCAAYC-3′ |
| 30 | cH1-1R | 5′-CTTYTCHAGTACTGTGTCAACAGTGTC-3′ |
| 31 | cH3-4F | 5′-AGCAGGGGATAATTCTATTAAYCATGAAG-3′ |
| 32 | cH3-4R | 5′-GGYACATCATAAGGGTARCAGTTGCTG-3′ |
| 33 | cH6-3F | 5′-GTCAATTCMATCATAGACAAAATGAACACAC-3′ |
| 34 | cH6-3R | 5′-CCTACCAAAACYAGACTGCTCGATACCGTACT-3′ |
| 35 | cH9-2F | 5′-TCATTCTACAGGAGYATGAGATGG-3′ |
| 36 | cH9-1R | 5′-CTGTTGTCACACTTGTTGTTGTRTC-3′ |

What is claimed is:

1. A simultaneous detection, differentiation and typing system of Newcastle disease and avian influenza viruses, comprising:
an oligonucleotide microarray;
avian virus specific probes, disposed on the oligonucleotide microarray and the avian viruses include Newcastle disease and avian influenza viruses; and
avian virus nucleic acid products, hybridized with the avian virus specific probes on the oligonucleotide microarray.

2. The system according to claim 1, wherein the avian virus specific probes are selected from at least one of Newcastle disease virus (NDV) probe sequences of SEQ ID No. 1˜5.

3. The system according to claim 1, wherein the avian virus specific probes are selected from at least one of avian influenza virus (AIV) probe sequences of SEQ ID No. 6˜22.

4. The system according to claim 1, wherein the avian virus nucleic acid products are amplified from multiplex RT-PCR utilizing at least one of avian virus specific primers.

5. The system according to claim 4, wherein the avian virus specific primers are selected from at least one of AIV primer sequences of SEQ ID No. 23˜36.

6. The system according to claim 1, wherein the oligonucleotide microarray is set on a biochip or a DNA chip.

7. The system according to claim 1, wherein each of the specific probes is disposed to each specific position of the microarray and the hybridization on the microarray produces identified patterns.


SEQUENCE LISTING (36 sequences)

SEQ ID NO: 1 - DNA, 24 bp, Artificial Sequence
  Description of Artificial Sequence Synthetic probe
gcccaaggataargaggcgtgtgc

SEQ ID NO: 2 - DNA, 19 bp, Artificial Sequence
  Description of Artificial Sequence Synthetic probe
agrcaraaacgmtttatag

SEQ ID NO: 3 - DNA, 22 bp, Artificial Sequence
  Description of Artificial Sequence Synthetic probe
gagaagacggaarcgctttata

SEQ ID NO: 4 - DNA, 19 bp, Artificial Sequence
  Description of Artificial Sequence Synthetic probe
agacaggggcgccttatag

SEQ ID NO: 5 - DNA, 20 bp, Artificial Sequence
  Description of Artificial Sequence Synthetic probe
gggaaacagggacgycttat

SEQ ID NO: 6 - DNA, 27 bp, Artificial Sequence
  Description of Artificial Sequence Synthetic probe
cctcaaagccgaratcgcgcagagact

SEQ ID NO: 7 - DNA, 35 bp, Artificial Sequence
  Description of Artificial Sequence Synthetic probe
ccwatgtgtgacgaattcatcaatgtgccggaatg

SEQ ID NO: 8 - DNA, 35 bp, Artificial Sequence
  Description of Artificial Sequence Synthetic probe
ccaatgtgtgatgaattcctgaatgtaccggaatg

SEQ ID NO: 9 - DNA, 30 bp, Artificial Sequence
  Description of Artificial Sequence Synthetic probe
gtgtgatgagttcctaaacgcaycggagtg

SEQ ID NO: 10 - DNA, 22 bp, Artificial Sequence
  Description of Artificial Sequence Synthetic probe
gctctgcgatctagayggagtg

SEQ ID NO: 11 - DNA, 28 bp, Artificial Sequence
  Description of Artificial Sequence Synthetic probe
gtacagggaagaggcaatgcaaaataga

SEQ ID NO: 12 - DNA, 28 bp, Artificial Sequence
  Description of Artificial Sequence Synthetic probe
atacagagaagaagcaatgcaaaataga

SEQ ID NO: 13 - DNA, 28 bp, Artificial Sequence
  Description of Artificial Sequence Synthetic probe
accatacycaatacagaacagagtcatt

SEQ ID NO: 14 - DNA, 26 bp, Artificial Sequence
  Description of Artificial Sequence Synthetic probe
gactagagattctatcatcgaagtat

SEQ ID NO: 15 - DNA, 25 bp, Artificial Sequence
  Description of Artificial Sequence Synthetic probe
accctrttcaagacgcccaatacac

SEQ ID NO: 16 - DNA, 25 bp, Artificial Sequence
  Description of Artificial Sequence Synthetic probe
acccttttcagaacgctcattacac

SEQ ID NO: 17 - DNA, 24 bp, Artificial Sequence
  Description of Artificial Sequence Synthetic probe
ccttggtgtgtatcaaattctygc

SEQ ID NO: 18 - DNA, 25 bp, Artificial Sequence
  Description of Artificial Sequence Synthetic probe
gcatcaactcagttaaraatggcac

SEQ ID NO: 19 - DNA, 29 bp, Artificial Sequence
  Description of Artificial Sequence Synthetic probe
gcagacacahtatgtataggctaccatgc

SEQ ID NO: 20 - DNA, 25 bp, Artificial Sequence
  Description of Artificial Sequence Synthetic probe
gctgacaccatctgtgtaggctacc

SEQ ID NO: 21 - DNA, 30 bp, Artificial Sequence
  Description of Artificial Sequence Synthetic probe
gggactgcacactratagatgccctactgg

SEQ ID NO: 22 - DNA, 27 bp, Artificial Sequence
  Description of Artificial Sequence Synthetic probe
ctgcacactgatagatgctctattggg

SEQ ID NO: 23 - DNA, 27 bp, Artificial Sequence
  Description of Artificial Sequence Synthetic primer
gaccagatytgcatyggttaycatgca

SEQ ID NO: 24 - DNA, 29 bp, Artificial Sequence
  Description of Artificial Sequence Synthetic primer
cctgatgaggcttcatgrytggaccaaga

SEQ ID NO: 25 - DNA, 20 bp, Artificial Sequence
  Description of Artificial Sequence Synthetic primer
catcaaaatgcacaaggrga

SEQ ID NO: 26 - DNA, 26 bp, Artificial Sequence
  Description of Artificial Sequence Synthetic primer
aaacatgatgccccgaagctaaacca

SEQ ID NO: 27 - DNA, 26 bp, Artificial Sequence
  Description of Artificial Sequence Synthetic primer
tgagycttctaaccgaggtcgaaacg

SEQ ID NO: 28 - DNA, 23 bp, Artificial Sequence
  Description of Artificial Sequence Synthetic primer
caggattggtcttgtctttagcc

SEQ ID NO: 29 - DNA, 29 bp, Artificial Sequence
  Description of Artificial Sequence Synthetic primer
agcaaaagcaggggaaaataaaadcaayc

SEQ ID NO: 30 - DNA, 27 bp, Artificial Sequence
  Description of Artificial Sequence Synthetic primer
cttytchagtactgtgtcaacagtgtc

SEQ ID NO: 31 - DNA, 29 bp, Artificial Sequence
  Description of Artificial Sequence Synthetic primer
agcaggggataattctattaaycatgaag

SEQ ID NO: 32 - DNA, 27 bp, Artificial Sequence
  Description of Artificial Sequence Synthetic primer
ggyacatcataagggtarcagttgctg

SEQ ID NO: 33 - DNA, 31 bp, Artificial Sequence
  Description of Artificial Sequence Synthetic primer
gtcaattcmatcatagacaaaatgaacacac

SEQ ID NO: 34 - DNA, 32 bp, Artificial Sequence
  Description of Artificial Sequence Synthetic primer
cctaccaaaacyagactgctcgataccgtact

SEQ ID NO: 35 - DNA, 24 bp, Artificial Sequence
  Description of Artificial Sequence Synthetic primer
tcattctacaggagyatgagatgg

SEQ ID NO: 36 - DNA, 25 bp, Artificial Sequence
  Description of Artificial Sequence Synthetic primer
ctgttgtcacacttgttgttgtrtc